(19) United States
(12) Patent Application Publication
(10) Pub. No.: US 2025/0349310 A1
(43) Pub. Date: Nov. 13, 2025

(54) SOUND PROCESSING METHOD AND DEVICE USING DJ TRANSFORM

(71) Applicant: BRAINSOFT INC., Seoul (KR)

(72) Inventor: Dong Jin KIM, Seoul (KR)

(21) Appl. No.: 19/230,596

(22) Filed: Jun. 6, 2025

Related U.S. Application Data
(63) Continuation-in-part of application No. 18/210,866, filed on Jun. 16, 2023, now abandoned.

(51) Int. Cl. G10L 21/0364; G10L 25/18

(52) U.S. Cl. CPC G10L 21/0364; G10L 25/18

(57) ABSTRACT

According to research findings, it is known that human hearing ability is not restricted by the Fourier uncertainty principle. The present disclosure intends to propose the sound processing method and device using the DJ transform method, a new frequency extraction method from understanding of the human hearing ability that improves the temporal resolution as well as the frequency resolution simultaneously based on the operating principle of hair cells constituting the cochlea.

### CROSS REFERENCE TO RELATED APPLICATION

This application is a continuation-in-part of U.S. application Ser. No. 18/210,866, filed on Jun. 16, 2023, which is a continuation-in-part of U.S. application Ser. No. 17/268,444, filed on Feb. 12, 2021, which claims the benefit of PCT/KR2019/016347 filed on Nov. 26, 2019, which claims the benefit of Korean patent application 10-2019-0003620 filed on Jan. 11, 2019. The entire disclosure of the foregoing applications is incorporated by reference herein.

### TECHNICAL FIELD

The present disclosure generally relates to sound processing method and device which can increase the temporal resolution as well as the frequency resolution simultaneously by extracting a frequency of an input sound using DJ transform. The frequency extracted according to the present invention can be used in various fields such as sound recognition and sound synthesis.

### BACKGROUND

The Short-time Fourier Transform (STFT) is used in various fields dealing with sound, such as speech recognition, speaker recognition, etc. to extract frequencies from a given sound. However, when frequencies are extracted by the STFT, there is a limitation on increasing the temporal resolution as well as the frequency resolution due to the Fourier uncertainty principle. The Fourier uncertainty principle states that if a sound of a short duration is transformed into a frequency component, then the resolution of the frequency component is relatively low, and if a sound with a longer duration is used to obtain a more precise frequency, then the temporal resolution for the instant when the frequency component is extracted decreases.

For example, when using the STFT, assume that a window size is 25 milliseconds, and a rectangular filter is used. The frequency component extracted under these conditions has a resolution of 40 Hz. In that case, even if 420 Hz frequency exists in an input sound, only 400 Hz frequency and 440 Hz frequency appear as the extraction result, and the 420 Hz frequency does not appear. For that reason, the distinction between a pure tone composed of 420 Hz frequency only and a complex tone composed of 400 Hz and 440 Hz frequencies is not clear. Now, assume that 4 KHz frequency exists on the extracted result. The extraction result does not give any information on the time point when the 4 kHz frequency occurred within the 25 milliseconds window. For example, it is not possible to distinguish whether the 4 KHz frequency occurred in the range of 0˜10 milliseconds or in the range of 10˜20 milliseconds.

In order to get a frequency resolution of 20 Hz, the window size should be extended to 50 milliseconds. However, since the temporal resolution is inversely proportionate to the frequency resolution, the temporal resolution decreases due to the 50 milliseconds window. Also, if the window size is reduced to 12.5 milliseconds to increase the temporal resolution, the frequency resolution is lowered to 80 Hz. Due to this trade-off, the temporal resolution and the frequency resolution cannot be improved simultaneously when using the STFT.

### SUMMARY

According to research findings, it is known that human hearing ability is not restricted by the Fourier uncertainty principle. The present disclosure intends to propose the sound processing method and device using the DJ transform method, a new frequency extraction method from understanding of the human hearing ability that improves the temporal resolution as well as the frequency resolution simultaneously based on the operating principle of hair cells constituting the cochlea.

A sound processing device comprising: A spring modeling unit that calculates displacement and velocity of each of the plurality of springs by modeling a plurality of springs, each of which has a different natural frequency and vibrates according to an input sound, and calculates displacement, velocity, energy, and amplitude of each of the plurality of springs by modeling a plurality of springs, each of which has a different natural frequency and vibrates according to an input pure tone; A frequency extraction unit that extracts the natural frequency of the spring corresponding to the local maximum among the filtered pure tone amplitudes calculated by the spring modeling unit; A sound recognition and synthesis unit that recognizes and synthesizes sound by using the amplitude or natural frequency of the input pure tone; and An error inspection unit that checks the excess error of the conversion result of the frequency when the frequency of the plurality of input springs changes and inspects the error between the pure tone frequencies;

A sound processing device of the present invention includes a spring modeling unit, a frequency extraction unit, a sound recognition and synthesis unit, and an error inspection unit.

A sound processing method according to the sound processing device of the present invention comprises the steps of: modeling, by a sound processing device, natural frequencies of a plurality of springs, the plurality of springs having natural frequencies different from each other and oscillating according to an input sound; estimating an expected steady-state amplitude of the spring of which the amplitude is the highest among the plurality of modeled springs; calculating an energy of at least one spring of the plurality of springs of which the amplitude is the highest based on the expected steady-state amplitudes; calculating an amplitude of the input pure tone based on the energy, and using, by a sound recognition and synthesis unit the amplitude of the input pure tone for sound recognition or sound synthesis.

Said the spring modeling unit comprises: a spring frequency modeling module that models natural frequencies of a plurality of springs having different natural frequencies and vibrating according to input sound; a filtered pure tone amplitude determination module that determines filtered pure tone amplitudes of the plurality of springs; an amplitude calculation module that calculates transient pure tone amplitudes of the modeled plurality of springs, calculates expected steady-state amplitudes of the modeled plurality of springs, calculates predicted pure tone amplitudes based on the expected steady-state amplitudes, and calculates filtered pure tone amplitudes by multiplying the transient pure tone amplitude by the predicted pure tone amplitude; an expected steady-state amplitude estimation module that estimates the expected steady-state amplitude of a spring having the largest amplitude among the modeled plurality of springs; a spring energy calculation module that calculates the energy of at least one spring having the largest amplitude among the plurality of springs based on the expected steady-state amplitude; and an input pure tone amplitude calculation module that calculates the amplitude of the input pure tone based on the energy;

Said the sound recognition and synthesis unit is characterized by performing speech recognition; speaker verification; speaker identification; source separation; sound direction detection; sound-based nomenclature diagnostics; sound-based machine fault diagnostics; or Sonar for navigation undersea terrain or ranging objects.

Said the error inspection unit is characterized in that, when the frequency of the plurality of input springs is maintained at a first value until a certain point of time and turns to a second value at the certain point, the frequency conversion result up to the certain point is indicated as the first value, and immediately after the turning point, the transient error from the first value to the second value is checked to be within 10%, thereby inspecting the error between pure tone frequencies.

A sound processing method comprising the steps of: modeling, by a spring modeling unit, natural frequencies of a plurality of springs, the plurality of springs having natural frequencies different from each other and oscillating according to an input sound;

determining, by the spring modeling unit, filtered pure-tone amplitudes of the plurality of springs: calculating, by the spring modeling unit, transient-state-pure-tone amplitudes of the plurality of modeled springs; calculating, by the spring modeling unit, expected steady-state amplitudes of the plurality of modeled springs; calculating, by the spring modeling unit, predicted pure-tone amplitudes based on the expected steady-state amplitudes; calculating, by the spring modeling unit, filtered pure-tone amplitudes by multiplying the transient-state-pure-tone amplitudes with the predicted pure-tone amplitudes; extracting, by a frequency extraction unit, a natural frequency of at least one spring of the plurality of springs which corresponds to a local maximum value among the filtered pure-tone amplitudes; and using, by a sound recognition and synthesis unit, the natural frequency for sound recognition or sound synthesis.

Said expected steady-state amplitude can be calculated based on the amplitudes at two different time points within a duration of the input sound. Said expected steady-state amplitude A_{i,s} can be calculated by means of

the equation below:

$${A}_{i , s} = \frac{{A}_{i} ( {t}_{2} ) - {A}_{i} ( {t}_{1} ) {e}^{- ζ ω ( {t}_{2} - {t}_{1} )}}{1 - {e}^{- ζ ω ( {t}_{2} - {t}_{1} )}}$$

where A_{i,s} is the expected steady-state amplitude of i-th spring Si among the plurality of springs, wherein I is a positive integer, where t₁ and t₂ are two different time points within a duration of input sound, t₂>t₁, Ai(t₁) is an amplitude of said spring Si at t₁, Ai(t₂) is an amplitude of said spring Si at t₂, ζ is a damping ratio of said spring Si, and ω satisfies the equation ω=ωᵢ\sqrt{1−2ζ²}, where ωᵢ is the natural frequency of said spring Si.

A difference between the two different time points can be a period of the natural frequency of the corresponding spring.

If one of the two time points is t₁, a sampling rate of the input sound is SR, and a period of the natural frequency of the corresponding spring is T, then the other t₂ of the two time points can be calculated by the equation below.

$${t}_{2} = [ {t}_{1} + SR \times T + 0.5 ]$$

The expected steady-state amplitude can be calculated by substituting amplitudes at least two points in the duration of the input sound into the following equation and using a linear regression analysis.

$$A ( t ) = {A}_{s} + ( {A}_{c} - {A}_{s} ) {e}^{- ζ ω ( t - {t}_{c} )}$$

where A(t) is an amplitude of any spring among said plurality of springs at t, Aₛ is the expected steady-state amplitude of said spring, A_{c} is an amplitude of said spring at t_{c}, t_{c} is a time point before the at least two points in the duration of the input sound, ζ is a damping ratio of said spring, and ω satisfies the equation ω=ωᵢ\sqrt{1−2ζ²}, where ωᵢ is the natural frequency of the spring.

the spring modeling unit is characterized by performing the steps of: measuring displacements and velocities at time points for each of the plurality of springs; calculating an energy at each time point for each of the plurality of springs based on the displacements and the velocities; and calculating an amplitude at each time point for each of the plurality of springs based on the energy.

The number of the plurality of springs may be determined based on a range and a resolution of the frequency to be extracted.

A sound processing method comprising the steps of: sampling, by a spring modeling unit, natural frequencies of a plurality of springs, the plurality of springs having natural frequencies different from each other and oscillating according to an input sound; estimating, by the spring modeling unit, an expected steady-state amplitude of the spring of which the amplitude is the highest among the plurality of modeled springs; calculating, by the spring modeling unit, an energy of at least one spring of the plurality of springs of which the amplitude is the highest based on the expected steady-state amplitudes; calculating, by the spring modeling unit, an amplitude of the input pure tone based on the energy; and using, by a sound recognition and synthesis unit, the amplitude of the input pure tone for sound recognition or sound synthesis.

Said the spring modeling unit is characterized by performing the steps of: measuring a displacement and a velocity at each time point for each of the plurality of springs; calculating an energy at each time point for each of the plurality of springs based on the displacement and the velocity; and calculating an amplitude at each time point for each of the plurality of springs based on the energy.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a configuration diagram of a sound processing device of the present invention. FIG. 2 is a configuration diagram of a spring modeling unit of the present

invention.

FIG. 3 is a configuration diagram of a sound recognition and synthesis unit of the present invention.

FIG. 4 is an example of a graph showing the displacement of a spring when an external force is zero;

FIG. 5 is an example of a graph showing the changes in amplitude of a spring when an external force is applied and disappears;

FIG. 6 is a flowchart showing sound processing method according to an embodiment of the present disclosure;

FIG. 7A is a graph showing the transient-state-pure-tone amplitude, and FIG. 7B showing the amplitude of the input pure tone;

FIGS. 8A, 8B, 8C, 8D, 8E, 8F, 8G, 8H and 8I show graphs for the transient-state-pure-tone amplitude, the predicted pure-tone amplitude, and the filtered pure-tone amplitude according to an embodiment of the present disclosure when 1 kHz sound with constant amplitude is input;

FIG. 9 shows a graph of the filtered pure-tone amplitude when a complex tone is input;

FIG. 10 shows a graph of the filtered pure-tone amplitude when a complex tone which is different from FIG. 9 is input;

FIG. 11 is a flowchart showing a sound processing method according to an embodiment of the present disclosure;

FIGS. 12A, 12B, 12C, 12D, 12E and 12F, are drawings which show the result of the STFT, the frequencies of the input sounds, and the result of the DJ transform according to the present disclosure when pure tones are input;

FIGS. 13A, 13B, 13C and 13D are drawings which show the results of the DJ transform according to the present disclosure when the frequencies of the input pure tones are changed;

FIGS. 14A, 14B, 14C and 14D are drawings which show the results of the STFT when the frequencies of the input pure tones are changed;

FIGS. 15A, 15 B and 15C are drawings which show the frequency components of the input signals, the results of DJ transform, and the results of the STFT when a flickering signal and a lasting signal are input;

FIGS. 16A, 16B and 16C are drawings which show the frequency components of an input sound, the results of the DJ transform and the STFT when 1 kHz and 2 kHz sounds are alternately input;

FIGS. 17A, 17B and 17C are drawings which show the results of the DJ transform and the STFT when a pure tone and a complex tone are input;

### DETAILED DESCRIPTION

The following description with reference to the accompanying drawings is provided to assist in a comprehensive understanding of various embodiments of the present disclosure.

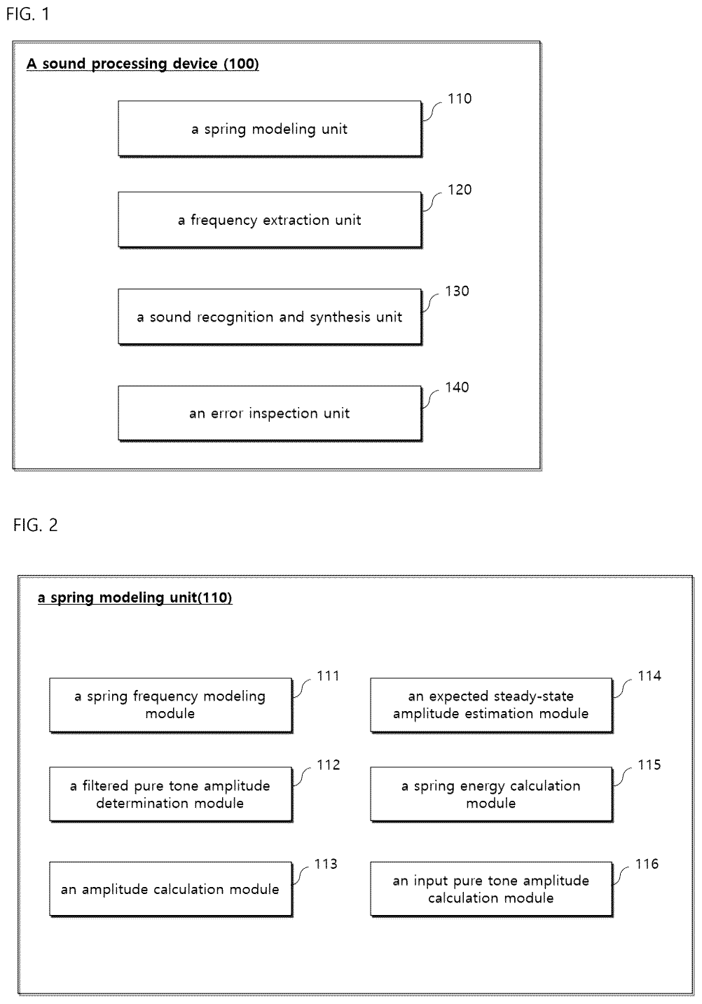

Referring to FIG. 1, the sound processing device (100) of the present invention includes a spring modeling unit (110), a frequency ex raction unit (120), a sound recognition and synthesis unit (130), and an error inspection unit (140).

The spring modeling unit (110) models the movement of hair cells using a plurality of springs that have different natural frequencies and vibrate according to input sounds.

Hair cells change mechanical signals generated from the basilar membrane into electrical signals and transmit signals to the primary auditory cortex. Hair cells are composed of approximately 3,500 inner hair cells and 12,000 outer hair cells, and each hair cell is sensitive to sounds of its own characteristic frequency. This characteristic of hair cells is similar to the phenomenon in which a spring resonates and its amplitude increases when it receives an external force of a frequency that matches its own natural frequency. Utilizing this similarity, the spring modeling unit (100) models the movement of hair cells using a plurality of springs.

The spring modeling unit (110) can calculate the displacement and velocity of each of the plurality of springs by modeling a plurality of springs, each of which has a different natural frequency and vibrates according to the input sound. In addition, the spring modeling unit (110) can calculate the displacement, velocity, energy, and amplitude of each of the plurality of springs by modeling a plurality of springs, each of which has a different natural frequency and vibrates according to the input pure tone.

The spring modeling unit (110) can calculate the transient pure tone amplitude of the modeled plurality of springs, calculate the expected steady-state amplitude of the modeled plurality of springs, calculate the predicted pure tone amplitude based on the expected steady-state amplitude, multiply the transient pure tone amplitude by the predicted pure tone amplitude to calculate the filtered pure tone amplitude, and estimate the expected steady-state amplitude of the spring with the largest amplitude.

To this end, as illustrated in FIG. 2, the spring frequency modeling unit (110) includes a spring frequency modeling module (111), a filtered pure tone amplitude determination module (112), an amplitude calculation module (113), an expected steady-state amplitude estimation module (114), a spring energy calculation module (115), and an input pure tone amplitude calculation module (116).

The spring frequency modeling module (111) performs a function of modeling the natural frequencies of a plurality of springs that have different natural frequencies and vibrate according to the input sound.

The filtered pure tone amplitude determination module (112) performs a function of determining the filtered pure tone amplitude of a plurality of springs. The amplitude calculation module (113) performs a function of

calculating transient pure tone amplitudes of a plurality of modeled springs, a function of calculating expected steady state amplitudes of a plurality of modeled springs, a function of calculating expected pure tone amplitudes based on the expected steady state amplitudes, and a function of calculating filtered pure tone amplitudes by multiplying the expected pure tone amplitudes by the transient pure tone amplitudes.

The expected steady state amplitude estimation module (114) performs a function of estimating the expected steady state amplitude of a spring having the largest amplitude among the plurality of modeled springs.

The spring energy calculation module (115) performs a function of calculating the energy of at least one spring having the largest amplitude among the plurality of springs based on the expected steady state amplitudes.

Here, the spring energy calculation module (115) can measure displacement and velocity for each of the plurality of springs at each point in time, and calculate energy for each of the plurality of springs at each point in time based on the displacement and velocity.

The input pure tone amplitude calculation module (116) performs a function of calculating the amplitude of the input pure tone based on the energy.

The frequency extraction unit (120) extracts the natural frequency of the spring corresponding to the local maximum among the filtered pure tone amplitudes calculated by the water spring modeling unit (110).

The sound recognition and synthesis unit (130) determines the filtered pure tone amplitudes of several springs and performs sound recognition or sound synthesis using the natural frequencies.

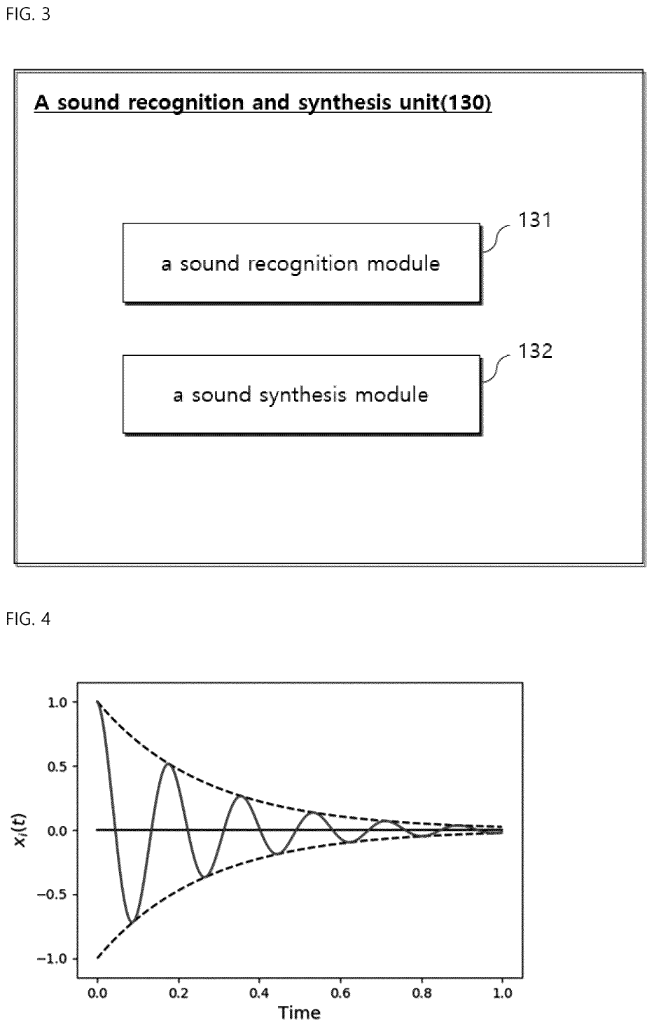

To this end, as shown in FIG. 3, the sound recognition and synthesis unit (130) includes a sound recognition module (131) and a sound synthesis module (132).

The sound recognition module (131) performs a function of recognizing sound using the amplitude or natural frequency of the input pure tone.

Here, sound recognition includes voice recognition in a narrow sense of converting human speech into text, speaker recognition that determines whose voice the input sound corresponds to, sound source separation such as distinguishing a specific person's voice when multiple speakers' voices are mixed, separating voice from noise when noise is mixed in the voice, or separating vocals excluding instruments in a song, sound direction detection, sound-based disease diagnosis such as coughing or breathing sounds, sound-based machine failure diagnosis using machine sounds, sonar for underwater terrain exploration or object distance measurement, etc.

The sound synthesis module (132) performs a function of synthesizing sound using the amplitude or natural frequency of the input pure tone.

The error checking unit (140) determines the frequency of multiple springs applied as input sounds. When input, maintains the first value until a certain point in time and changes to a second value at said certain point in time, the frequency conversion result up to said certain point in time is represented as the first value, and immediately after said changing point in time, checks whether the transient error from said first value to said second value is within 10% to examine the error between pure tone frequencies. In one embodiment, the sound processing device (100) of the present

invention may be configured as a SoC (System-on-a-chip) that receives sound in the form of wav data and extracts frequency at a constant cycle (e.g., 1 msec). Therefore, each of the components, a spring modeling unit (110), a frequency extraction unit (120), a sound recognition and synthesis unit (130), and an error inspection unit (140), may be components that operate through the hard-wired logic of the SoC.

In another embodiment, the sound processing device (100) of the present invention may be a DSP (Digital Signal Processor) that receives sound in the form of wav data and extracts frequency at a constant cycle (e.g., 1 msec). Therefore, each of the components, a spring modeling unit (110), a frequency extraction unit (120), a sound recognition and synthesis unit (130), and an error inspection unit (140), may be components of a programming code that operates in the DSP.

Through the above examples, the sound processing device (100) of the present invention can be used as a main component of a voice device such as a volume amplifier, a voice recognizer, a noise canceller, etc.

The process in which the sound processing device (100) of the present invention performs sound recognition and sound synthesis by utilizing the similarity between hair cells and water springs is as follows.

Hair cells convert mechanical signals generated in the basement membrane into electrical signals and transfer the signals to the primary auditory cortex. Hair cells consist of about 3,500 inner hair cells and 12,000 external hair cells, and each hair cell reacts sensitively to the sound of its own natural frequency. This characteristic of hair cells is similar to a phenomenon occurred in a spring of which amplitude increases because of resonance when the spring receives an external force with a frequency that matches the natural frequency of the spring. Using this similarity, the sound processing device (100) of present invention models the behavior of hair cells using a plurality of springs.

The human audible frequency is known to be in the range of 20˜20,000 Hz and the human voice frequency is known to be in the range of 80˜8,000 Hz. The frequency range covered in the field such as speech recognition is within 8 kHz. Considering the same, when used for a voice processing, the natural frequencies of the springs from 50 Hz to 8 kHz are classified by 1 Hz intervals, and 7,951 different types of springs can be used based on those natural frequencies. This means that the frequency resolution is 1 Hz unit. However, this is only an example, and widening the frequency range or increasing the resolution by using more springs is possible.

The behavior of a hair cell modeled by a spring can be represented as a differential equation of motion for driven harmonic oscillations. A sound corresponds to an external force made up of a combination of various sine waves which are applied to a spring. Each spring has its own natural frequency and draws its own motion trajectory by a series of sound samples. The motion trajectory of each spring can be obtained by calculating the solution of the differential equation of motion for driven harmonic oscillations using numerical analysis techniques such as the Runge-Kuta method.

Assume that ωi is the natural frequency of a spring Si (1≤i≤N). The spring Si is used to model the response of a hair cell that are most sensitive to the sound of ωi frequency among the hair cells constituting the human hearing system.

When the sound F0cos(ωt) is input, the reaction xi(t) of the spring Si to the sound can be represented by the equation of motion of the following equation (1):

$$\frac{{d}^{2} {x}_{i}}{{dt}^{2}} + 2 ζ {ω}_{i} \frac{{dx}_{i}}{dt} + {ω}_{i}^{2} {x}_{i} = \frac{{F}_{0} cos ( ω t )}{m} \qquad ( 1 )$$

where xᵢ is the length of the spring which deviates from the balance point (displacement), and m is the mass of the object suspended in the spring. ζ is a damping ratio and when a friction coefficient is bᵢ,

$$ζ = \frac{{b}_{i}}{2 \sqrt{{mk}_{i}}} .$$

kᵢ is a spring constant. ωi is the natural frequency of the spring when both ζ and Fᵢ are zero, and ωᵢ=\sqrt{kᵢ/m}.

Equation (1) is a differential equation with a general solution. When ζ<1, the solution is the same as the equation (2) below.

$${x}_{i} ( t ) = {A}_{i} {e}^{- ζ {ω}_{i} t} cos ( \sqrt{1 - {ζ}^{2}} {ω}_{i} t + {β}_{i} ) + \frac{{F}_{0}}{{mZ}_{i}} cos ( ω t + {φ}_{i} ) \qquad ( 2 )$$

where Aᵢ and βᵢ are determined by the initial conditions of the spring, and Zᵢ and φᵢ are as below:

$${Z}_{i} = \sqrt{{( 2 {ω}_{i} ω ζ )}^{2} + {( {ω}_{i}^{2} - {ω}^{2} )}^{2}} \qquad ( 3 )$$

$${φ}_{i} = arctan ( \frac{2 ω {ω}_{i} ζ}{{ω}^{2} - {ω}_{i}^{2}} ) + n π \qquad ( 4 )$$

The integer n is specified so that qi is between −180° and 0°. If F0=0, the spring is subjected to periodically damping oscillation as shown in FIG. 1. If F0>0 and the spring reaches a steady state after a certain period of time, the first term in the equation (2) disappears and the second term remains only so that the trajectory Xi,s(t) of the spring in a steady state follows the equation (5).

$${x}_{i , s} ( t ) = \frac{{F}_{0}}{{mZ}_{i}} cos ( ωt + {φ}_{i} ) \qquad ( 5 )$$

Consider a situation in which a sound having a frequency identical with the natural frequency ωi of a spring Si in a stop state is applied to the spring as an external force. The behavior of the spring in the process of reaching a steady state is described by the equation (6) below.

$${x}_{i} ( t ) = ( 1 - {e}^{- ζ {ω}_{i} t} ) {x}_{i , s} ( t ) \qquad ( 6 )$$

Therefore, the amplitude Aᵢ(t) of the spring gradually increases along the trajectory of

$${A}_{i} ( t ) = \frac{{F}_{0}}{{mZ}_{i}} ( 1 - {e}^{- ζ {ω}_{i} t} )$$

and finally becomes

$$\frac{{F}_{0}}{{mZ}_{i}} .$$

As the external force disappears at the point tₒ, the amplitude of the spring gradually decreases to zero. This corresponds F₀=0 in the equation (2), and the amplitude change in this process follows the equation below.

$${A}_{i} ( t ) = {A}_{i} ( {t}_{0} ) {e}^{- ζ {ω}_{i} ( t - {t}_{0} )} \qquad ( 7 )$$

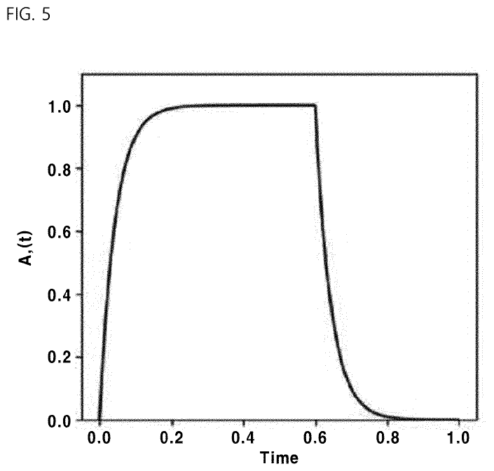

FIG. 5 is an example of a graph showing the changes in amplitude of a spring when an external force is applied and disappears.

According to the embodiments of the sound processing device (100) of the present invention, two methods for extracting the frequency and amplitude of the input sound are proposed based on the behavior of the spring modeled as hair cells.

### Method I for Extracting the Frequency and Amplitude of the Input Sound

1. In a steady state
(1) Extraction of frequency

Based on the characteristic that a resonating spring oscillates with a greater amplitude than other springs, a frequency of an input sound can be extracted.

Given a pure sound Fₒcos(ωt), an amplitude of a spring Si in a steady state becomes

$$\frac{{F}_{0}}{{mZ}_{i}}$$

by the equation (5). If the mass m of the object suspended in each spring is equal to each other, the spring with the greatest amplitude is the spring having the minimum Zᵢ. The relationship between the natural frequency ωᵢ of the spring and the frequency ω of pure tone can be obtained by differentiating Equation (3) with respect to ωᵢ, and the result is as follows:

$$ω = {ω}_{i} \sqrt{1 - 2 {ζ}^{2}} \qquad ( 8 )$$

where <1/\sqrt{2}. If (is a small value near zero, then ω˜ωᵢ. For example, ζ could be 0.001.

In order to find out the spring having the greatest amplitude, a numerical analysis method such as Runge-Kuta, which solves differential equations, is used. Given a pure sound Fₒcos(ωt), the displacement xᵢ(t) and the velocity vᵢ(t) of each spring Sᵢ which corresponds to the solution of equation (1) are calculated using the numerical analysis method. Since an energy of each spring is the sum of a kinetic energy and a potential energy, the energy of spring Sᵢ can be obtained by equation (9).

$${E}_{i} = \frac{1}{2} {k}_{i} {{x}_{i}}^{2} + \frac{1}{2} {{mv}_{i}}^{2} \qquad ( 9 )$$

The energy of the spring that has reached a steady state maintains a constant value. Thus, the displacement xᵢ at the time when the velocity vᵢ is 0 becomes the amplitude of the spring Sᵢ. Therefore, the amplitude Aᵢ of spring Sᵢ in a steady state can be calculated by the equation below:

$${A}_{i} = \sqrt{\frac{2 {E}_{i}}{{k}_{i}}} \qquad ( 10 )$$

The spring having the largest amplitude among the extracted amplitudes of the springs is the resonating spring. Therefore, it is possible to obtain the frequency of an input pure tone by using both the natural frequency ωi of the spring having the largest amplitude and the equation (8).

### (2) Extraction of Amplitude

In a steady state, the trajectory of the spring is given by the equation (5). Therefore, the relationship between an energy of a spring in a steady state, E_{i,s}, and an amplitude Fₒ of a given pure tone can be represented by the equation (11).

$${E}_{i , s} = \frac{1}{2} {{k}_{i} ( \frac{{F}_{o}}{{mZ}_{i}} )}^{2} \qquad ( 11 )$$

In addition, the energy in a steady state, E_{i,s}, can be obtained by putting the displacement xᵢ and the velocity vᵢ in the steady state, which are obtained by solving the equation (1) with the numerical analysis method, into the equation (9). Therefore, the amplitude Fₒ of a given pure tone becomes as below:

$${F}_{o} = {mZ}_{i} \sqrt{\frac{2 {E}_{i , s}}{{k}_{i}}} \qquad ( 12 )$$

The natural frequency ωᵢ of the spring that resonates with an external force is almost the same with the frequency of the external force. Therefore, if putting ω˜wᵢ into the equation (3), then Zi=2ωᵢ²ζ. If putting both of this result and ωi=\sqrt{kᵢ/m} into the equation (12), the amplitude F₀ of the input pure tone can be calculated by the equation (13).

$${F}_{o} = 2 {ζω}_{i} = \sqrt{2 {mE}_{i , s}} \qquad ( 13 )$$

2. In a transient state
(1) Extraction of frequency

Assume that a pure tone Fₒcos(ωt) is given over a time interval [tₐ, t_{b}]. All springs start to move in an initial state where both displacements and velocities are zero. Using the numerical analysis technique, the energies of the springs are calculated at each time point, and the calculated results are put into the equation (10) to obtain the amplitudes of the springs at each time point. After that, the natural frequency of the spring having the largest amplitude is substituted into the equation (8) to calculate the frequency of the given pure tone.

(2) Extraction of amplitude

Assume that an energy of a resonating spring Sᵢ found by the numerical analysis is Eᵢ(t). The amplitude Aᵢ(t) of a spring Sᵢ at time t can be calculated from Eᵢ(t) using the equation (10).

According to the general solution of the equation (1), the amplitude Aᵢ(t) of the spring Sᵢ resonating with a given sound wave follows the trajectory of the equation (6), so that the spring Sᵢ follows the trajectory of Aᵢ(t)=(1−e^{ζω(t-t}^{ₐ}⁾)A_{i,s} in a time interval [tₐ, t_{b}] starting from the initial state until it reaches the steady state. Here, A_{i,s} is the amplitude of the spring when it reaches the steady state. We call it an expected steady-state amplitude.

The energies Eᵢ(t₁) and Eᵢ(t₂) at two time points t₁, t₂ within the time interval [tₐ, t_{b}] can be obtained with the numerical analysis method. Therefore, the amplitudes Ai(t₁) and Ai(t₂) can be obtained by substituting these results into the equation (10). The expected steady-state amplitude, A_{i,s}, can be obtained by putting the result into Aᵢ(t)=(1−e^{ζω(t-t}^{ₐ}⁾)A_{i,s}, and the result is as the equation below:

$${A}_{i , s} = \frac{{A}_{i} ( {t}_{2} ) - {A}_{i} ( {t}_{1} ) {e}^{- ζω ( {t}_{2} - {t}_{1} )}}{1 - {e}^{- ζω ( {t}_{2} - {t}_{1} )}} \qquad ( 14 )$$

Next, regarding the case where the frequency is the same but the volume of the sound changes, assume that the amplitude of the sound given at the point t_{c} has changed from F₁to F₂. Let A_{c} be the amplitude of a spring at the time point t_{c} and let Aₛ be the amplitude of a spring at the time the spring will have approached a steady state after the external force changes to F₂. The behavior of the amplitude over time can be described by the following equation.

$$A ( t ) = {A}_{s} + ( {A}_{c} - {A}_{s} ) {e}^{- ζω ( t - {t}_{c} )} \qquad ( 15 )$$

Given the amplitudes A(t₁) and A(t₂) at two time points t₁ and t₂ within the time interval that the amplitude changes from A_{c} to Aₛ, it can be seen that the obtained Aₛ is the same as Equation (14).

For example, consider the case where the external force F₂=0 at the time point t_{c}. When the external force disappears, the energy of the spring decreases exponentially according to the equation (7). Namely, the measured amplitude of the spring after ΔT seconds from the time when the external force disappears will be A(t_{c}+ΔT)=A(t_{c})e^{-ζωΔt}. Putting this measurement result into the equation (14) makes Aₛ=0, and it means the external force has disappeared.

Therefore, the expected steady-state amplitude, As, can be obtained by measuring the energy of the spring more than once. Using equation (10) which represents the correlation between amplitude and energy, the energy in the steady state, Es, can be calculated and consequently the amplitude Fo of a given pure tone can be calculated using the equation (13).

Since the force applied to the spring is in the form of a periodic function, the energy does not increase uniformly within a period of a transient state. Considering this characteristic, when selecting the two time points ti and t₂ described above, the time interval is made to be the same with the period.

In this regard, it may not be able to select two time points of which a time difference between them is one period due to the relationship between the sampling rate of the sound data and the natural frequency of the spring. In this case, an error may occur, and two methods can be used to correct this error.

The first method is to select an adjacent sample which shows a less difference with a period. When the position S₁ of a sample and the period T of an audio data are given, the position S₂ of the second sample is calculated as [S₁+sampling rate×T+0.5]. The expected steady-state amplitude, Aₛ, is calculated by putting the time information of the two points and the amplitudes at the two points into the equation (14).

The second method uses a linear regression analysis. After extracting the amplitude at several points and putting the extracted data into the equation (15), the expected steady-state amplitude, Aₛ, is calculated by the linear regression analysis.

Based on the above theoretical background, a method for extracting a frequency of an input sound can be proposed as below.

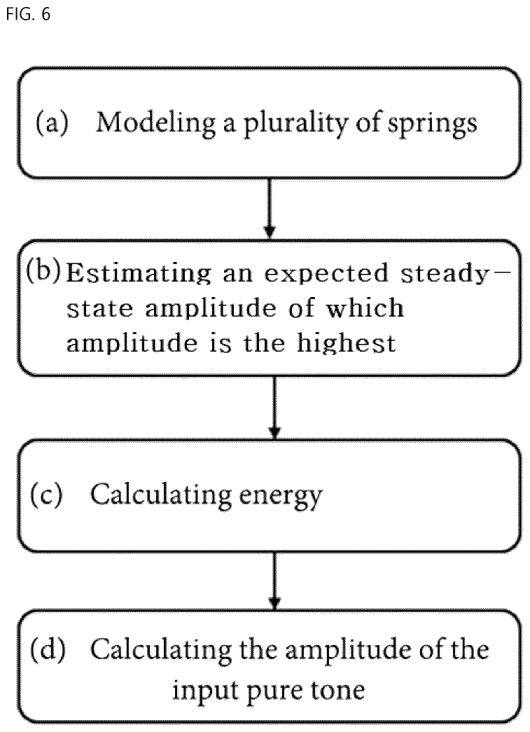

Referring FIG. 6, a method, of which each step is performed by the sound processing device (100), for extracting a frequency of an input sound according to an embodiment of the present disclosure may comprise the steps of:
(a) modeling, by a spring modeling unit (110), a plurality of springs which have natural frequencies different from each other and oscillate in accordance with the input sound;
(b) estimating, by a spring modeling unit (110), an expected steady-state amplitude, A_{i,s}, of the spring of which amplitude Aᵢ(t) is the highest among the plurality of modeled springs;
(c) calculating, by a spring modeling unit (110), an energy E_{i,s} of said spring of which amplitude is the highest based on the expected steady-state amplitude, A_{i,s}; and
(d) calculating, by a spring modeling unit (110), the amplitude F₀ of the input sound based on said energy E_{i,s}.

The step (a) may comprise the steps of: measuring displacements xᵢ(t) and velocities vᵢ(t) at time points for each of the plurality of springs (see the equation 1); calculating energy Eᵢ(t) at each time point for each of the plurality of springs based on the displacements and the velocities (see the equation 9); and calculating an amplitude Aᵢ(t) of each of the plurality of springs based on the energies Eᵢ(t) (see the equation 10).

The step (b) can be calculated with the equation (14).

In the step (b), said expected steady-state amplitude, A_{i,s}(t), can be calculated based on the amplitudes at two different time points within a duration of the input sound.

A difference between the two different time points can be a period of the natural frequency of the corresponding spring.

When one of the two time points is t₁, a sampling rate of the input sound is SR, and the period of the natural frequency of the corresponding spring is T, the other t₂ of the two time points can be calculated by means of the equation below.

$${t}_{2} = [ {t}_{1} + SR \times T + 0.5 ]$$

The number of the plurality of springs N may be determined based on a range and a resolution of the frequency to be extracted.

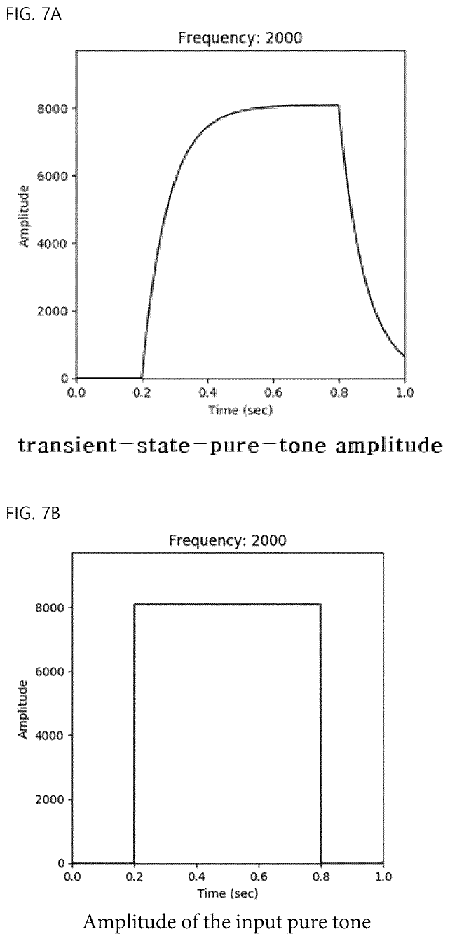

FIGS. 7A to 7C are graphs representing the experimental results according to embodiments of the present disclosure.

FIG. 7A shows the result obtained by putting the energy E2000 (t) of a spring, of which natural frequency is 2 kHz over time when a pure tone having a frequency of 2 kHz with a constant amplitude is input between 0.2 and 0.8 seconds, into the equation (13). This result is called a transient-state-pure-tone amplitude. The transient-state-pure-tone amplitude is an amplitude of the input pure tone which is calculated under the assumption that there is no change in the energy of the spring. As time goes by, the energy of the spring reaches a steady state. Therefore, as shown in FIG. 7A, the transient-state-pure-tone amplitude gradually reaches a steady state, and the amplitude at this time corresponds to the amplitude Fₘ(t) of the input pure tone. Here, m indicates a natural frequency of a spring.

FIG. 7B shows the amplitude Fₘ(t) of the input pure tone that is obtained by putting the measured amplitude of the spring into the equation (14) to obtain the expected steady-state amplitude of the spring, A_{m,s}(t), and applying the results to the steps (c) and (d) of the frequency extraction method above. As shown in FIG. 7B, the amplitude of the input pure tone is extracted from the starting point of the pure tone.

### Method II for Extracting the Frequency and Amplitude of the Input Sound

According to the method I for extracting the frequency and amplitude of the input sound described above, if the input sound is a pure tone, the frequency and amplitude of the input sound can be effectively extracted.

Now, assume that there are n types of pure tones constituting a complex tone F(t)=ΣⱼFⱼcos(ωⱼt+Δⱼ). If n =1, the pure tone of a given sound can be found by selecting the spring having the largest amplitude among the springs. However, if n>1, it is difficult to find out pure tones constituting the complex tone by selecting top n springs in the order of amplitude.

The first reason is that the amplitude of a spring of which the frequency is adjacent to the spring having the largest amplitude could be greater than the amplitude of the spring which resonates with other pure tones constituting the complex tone. The second reason is that, as shown in the trajectory after 0.8 seconds in FIG. 5, even though the external force disappears, it takes time until the amplitude of the spring reaches 0, so the amplitude of the sound that does not exist anymore could be greater than the amplitude of other pure tones.

Accordingly, in this embodiment, instead of finding the local maximum value among the spring amplitudes at each time point, a method of finding the local maximum value from the results of multiplying an expected steady-state amplitude and a transient-state-pure-tone amplitude is proposed.

### 1. Expected Steady-State Amplitude and Filtered Pure-Tone Amplitude

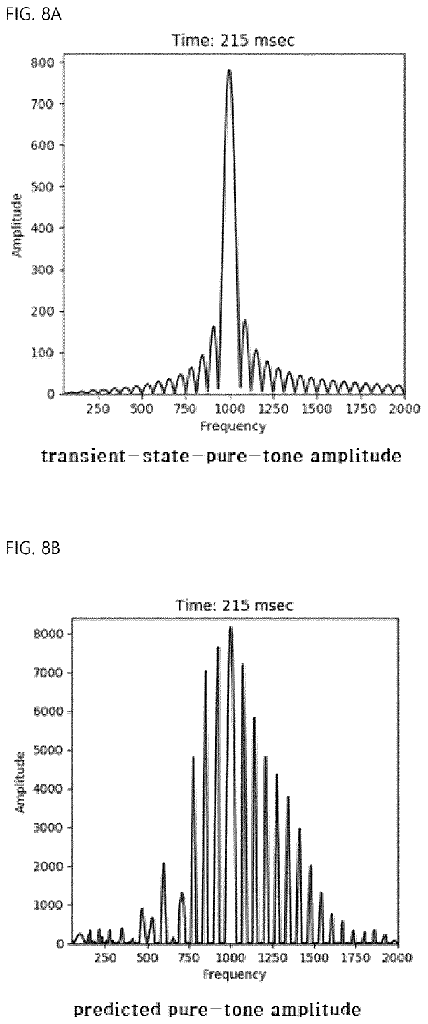

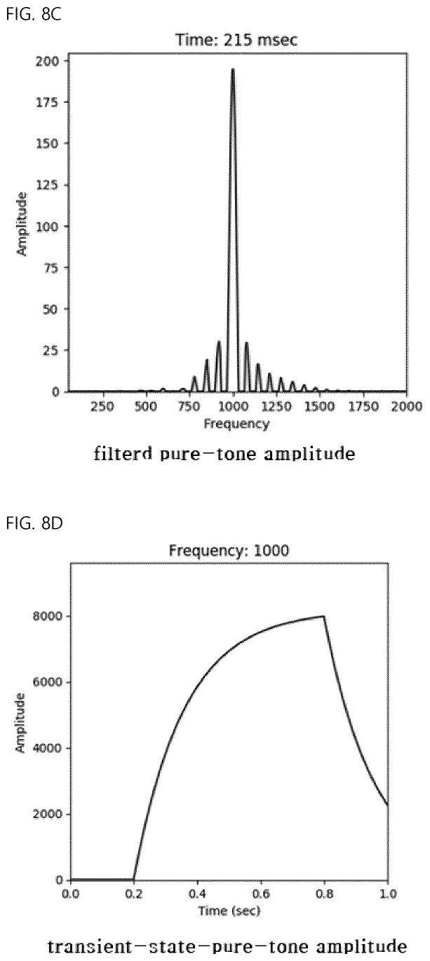

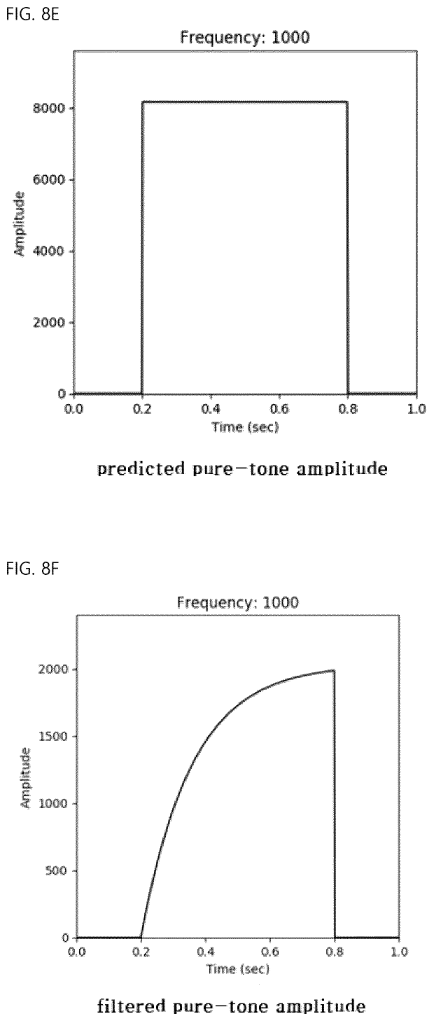

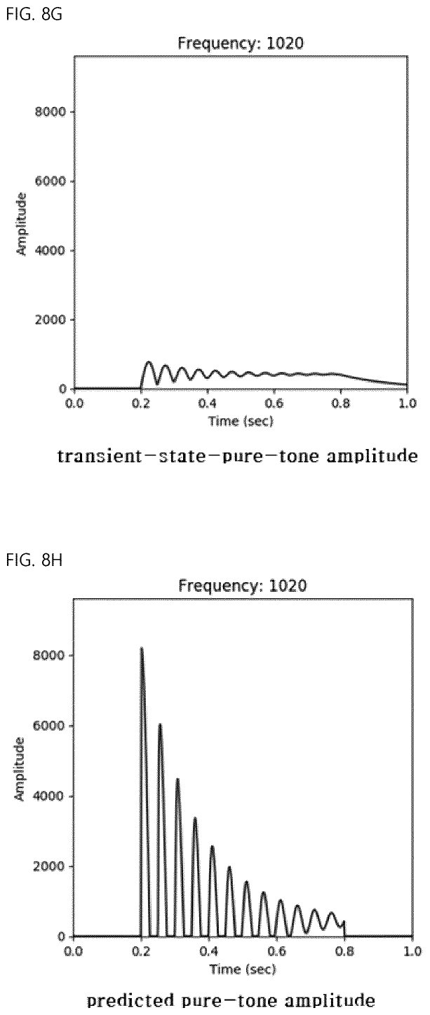

First, in order to extract the pure tones constituting a complex tone, the amplitude Aᵢ(t) of each spring Sᵢ is calculated by applying the step (a) of the method I to each spring for extracting the frequency of an input sound. FIG. 8A shows the amplitudes of springs of which natural frequencies are around 1 kHz as a result measured at 215 milliseconds when a sound having a frequency of 1 kHz with a constant amplitude starts at 200 milliseconds. FIG. 8A shows that the amplitude of the spring that does not resonate is lower than that of the spring that resonates.

Next, an expected steady-state amplitude, A_{i,s}(t), is calculated by applying the step (b) of the method I for extracting the frequency of an input sound to the amplitude Aᵢ(t) of each spring Si. However, the equation (14) which calculates the expected steady-state amplitude is an equation derived from the equation (7) which describes the behavior of a resonating spring. Therefore, high amplitudes could be resulted even at the frequencies away from the resonant frequency as in FIG. 8B.

Accordingly, the following steps are performed. The third step is to calculate a transient-state-pure-tone amplitude, F_{i,t}(t), by putting the amplitude Aᵢ(t) of the spring Sᵢ into the equation (13). In addition, a predicted pure-tone amplitude, F_{i,s}(t), is calculated by applying steps (c) and (d) of the method I for extracting the frequency of the input sound to the expected steady-state amplitude, A_{i,s}(t).

As the final step, a filtered pure-tone amplitude, F_{i,p}(t), is calculated by multiplying the transient-state-pure-tone amplitude, F_{i,t}(t), with the predicted pure-tone amplitude, F_{i,s}(t), as in F_{i,p}(t)=F_{i,st}(t)×F_{i,s}(t). Additionally, the result of multiplication of the amplitudes may be divided by the maximum amplitude of the sound in order not to exceed 1 but to be normalized. For example, if the sound is expressed as a 16-bit integer, the result is divided by 32,767.

A filtered pure-tone amplitude has the characteristic that 1) the amplitude becomes 0 when the sound disappears, and 2) the amplitudes of frequencies away from a resonant frequency in the frequency domain are low.

FIG. 8C shows the filtered pure-tone amplitude, which is the result of multiplication of the amplitudes in FIGS. 8A and 8B with respect to the same frequency.

FIGS. 8D to 8F show the transient-state-pure-tone amplitude, the predicted pure-tone amplitude, and the filtered pure-tone amplitude obtained by the spring with a natural frequency of 1 kHz, respectively. Especially, it is shown that, after the input sound disappears at 0.8 seconds, the amplitude in FIG. 8D remains not to be zero, but the amplitudes in FIG. 8E and 8F become zero. FIG. 8G to 8I show the results for the spring with the natural frequency of 1,020 Hz. Apparently, the filtered pure-tone amplitude, F_{1020,p}(t), is very small compared to the filtered pure-tone amplitude, F_{1000,p}(t), of the resonating spring of FIG. 8F.

2. Finding a Pure Tone from Local Maximum Values

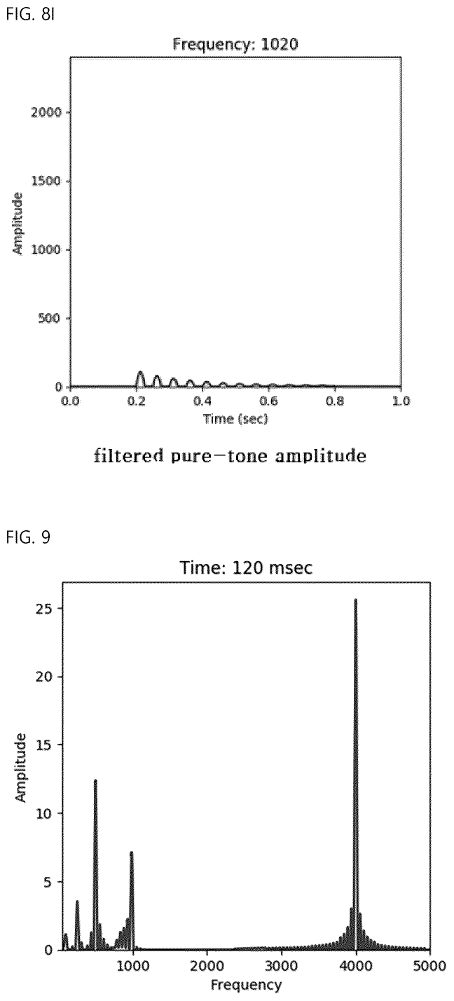

FIG. 9 is a graph showing frequency vs. filtered pure-tone amplitude of a complex tone composed of five pure tones of 100 Hz, 250 Hz, 500Hz, 1 kHz, and 4 kHz. As shown in FIG. 9, if frequency intervals of the sounds constituting the complex tone are broad, each pure tone frequency generates a local maximum value among local maximum values in a frequency. Using these characteristics, several local maxima are obtained from a frequency vs. amplitude graph obtained by using the filtered pure-tone amplitude. Then the local maxima of those several local maxima are obtained again. Finally, frequencies corresponding to the local maxima are regarded as frequencies of the pure tones constituting the complex tone.

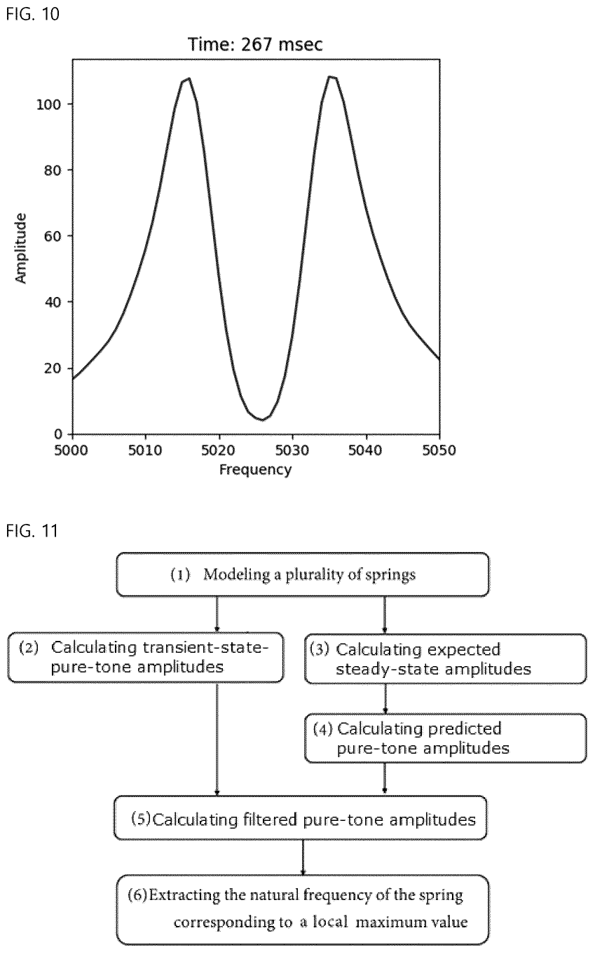

However, if the frequency interval is narrow, no local maximum might exist between two adjacent local maxima. FIG. 10 is a part of the graph for frequency vs. filtered pure-tone amplitude of a complex tone composed of five pure tones of 112 Hz, 181 Hz, 1,034 Hz, 5,017 Hz, and 5,034 Hz. It shows that no local maximum exists between the two local maxima that are generated by the two adjacent frequencies, 5,017 Hz and 5,034 Hz. The characteristic of this case is that the frequency interval is narrow and the two filtered pure-tone amplitudes are similar. Therefore, if the frequency difference between of two adjacent local maxima in filtered pure-tone amplitudes is within a certain width (e.g., the bandwidth of a high-amplitude frequency) and the ratio of those filtered pure-tone amplitudes is equal to or greater than a certain level (e.g. 0.5), both frequencies are treated as the frequencies of pure tones constituting the complex tone.

Based on the theoretical background described above, the following method for extracting the frequency of the input sound is proposed.

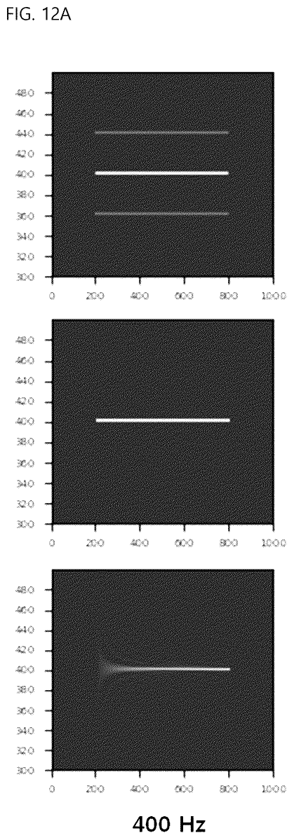

Referring FIG. 11, a method, of which each step is performed by the sound processing device (100), for extracting a frequency of an input sound according to an embodiment of the present disclosure comprises the steps of:
(1) modeling, by a spring modeling unit (110), a plurality of springs, each spring Sᵢ(1≤i≤N) of which has natural frequencies ωᵢ, being different from each other, and oscillates according to the input sound;
(2) calculating, by a spring modeling unit (110), transient-state-pure-tone amplitudes of the plurality of modeled springs at each time t, {F_{i,t}(t)|1≤i≤N}, based on displacements and velocities of the modeled springs;
(3) calculating, by a spring modeling unit (110), expected steady-state amplitudes of the plurality of modeled springs at each time t, {A_{i,s}(t)|1≤i≤N};
(4) calculating, by a spring modeling unit (110), predicted pure-tone amplitudes, {F_{i,s}(t)|1≤i≤N}, based on the expected steady-state amplitudes at each time t, {A_{i,s}(t)|1≤i≤N};
(5) calculating, by a spring modeling unit (110), filtered pure-tone amplitudes at each time t, {F_{i,s}(t)|1≤i≤N}, by multiplying the transient-state-pure-tone amplitude, F_{i,t}(t), with the predicted pure-tone amplitude, F_{i,s}(t), for each spring Sᵢ;
(6) extracting, by a frequency extraction unit (120), natural frequencies of the springs, each filtered pure-tone amplitude of which is a local maximum in a frequency range; and
(7) using, by a sound recognition and synthesis unit (130), the natural frequency for sound recognition or sound synthesis.

The step (1) may comprise the steps of: measuring displacements xᵢ(t) and velocities vᵢ(t) at different time points for each of the plurality of springs (see the equation 1); calculating an energy Eᵢ(t) at each time point for each of the plurality of springs based on the displacements xᵢ(t) and the velocities vᵢ(t) (see the equation 9); and calculating an amplitude Aᵢ(t) at each time point for each of the plurality of springs based on the energy Eᵢ(t) (see the equation 10).

The equation 13 can be used in the step (2), the equation 14 can be used in the step (3), and the equation 13 can be used in the step (4).

The number of the plurality of springs, N, may be determined based on a range and a resolution of the frequencies to be extracted.

In the step (3), the expected steady-state amplitudes, A_{i,s}(t), can be calculated based on the amplitudes at two time points within a duration of the input sound.

In the step (3), the expected steady-state amplitudes, A_{i,s}(t), can be calculated by means of the equation below:

$${A}_{i , s} = \frac{{A}_{i} ( {t}_{2} ) - {A}_{i} ( {t}_{1} ) {e}^{- ζω ( {t}_{2} - {t}_{1} )}}{1 - {e}^{- ζω ( {t}_{2} - {t}_{1} )}}$$

where t₁ and t₂ are the two different time points within the duration of input sound, t₂>t₁, Ai(t₁) is an amplitude of any spring among the plurality of springs at t₁, Ai(t₂) is an amplitude of said spring at t₂, ζ is a damping ratio of said spring, and ω satisfies the equation ω=ωᵢ\sqrt{1−2ζ²}, where ωᵢ is the natural frequency of said spring.

A difference between the two different time points can be a period of the natural frequency of the corresponding spring.

When one of the two time points is t1, a sampling rate of the input sound is SR, and a period of the natural frequency of the corresponding spring is T, the other t2 of the two time points is calculated by the equation below.

$${t}_{2} = [ {t}_{1} + SR \times T + 0.5 ]$$

In step (7), the natural frequency may be used for sound recognition or sound synthesis.

The sound processing method and sound processing apparatus according to the sound processing device (100) of the present invention can be applied not only to human voice but also to all types of sounds such as objects such as musical instruments and animals. In the present disclosure, sound recognition includes: speech recognition in a sense of converting human speech into text; speaker verification/speaker identification for determining whose voice an input sound corresponds to; source separation such as discrimination of a specific person's voice in a state in which the voices of a plurality of speakers are mixed, separation of voice from noise when noise is mixed, and separation of vocals from songs excluding instruments; sound direction detection; sound-based nomenclature diagnostics such as coughing or breathing; sound-based machine fault diagnostics based on mechanical sounds; and Sonar for navigating undersea terrain, ranging objects and more.

Sound recognition or sound synthesis are example to which the natural frequency obtained by the present invention can be applied, and the scope of the present invention is not limited thereto. The present invention can be applied to any field in which periodic properties or Fourier transforms are used such as price prediction for cryptocurrencies and stocks and image processing such as denoising.

Hereinafter, the experimental results according to the sound processing device (100) of the present invention will be described. To show the performance of the DJ transform according to the present disclosure, the results of the DJ transform and that of the STFT were compared. In the DJ transform, 7,951 springs of which natural frequencies are from 50 Hz to 8,000 Hz were used, respectively. The frequency interval of springs was 1 Hz. A 25 milliseconds window was used for the STFT.

The DJ transform was performed in an NVIDIA M40 GPU environment with 3,072 cores and 12 GB of memory and was implemented using the C language API of Cuda Toolkit 8.0. It took about 0.6 seconds to do the DJ transform for a 1 second audio data.

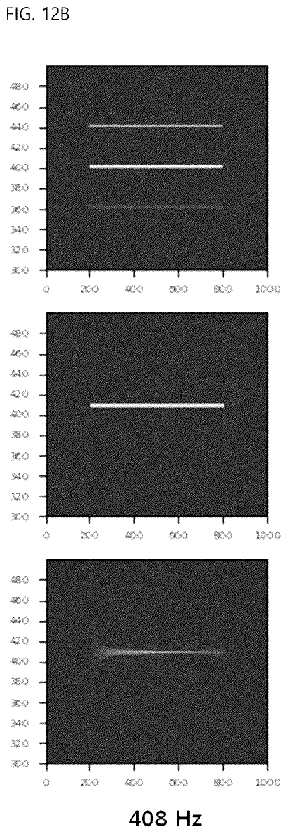

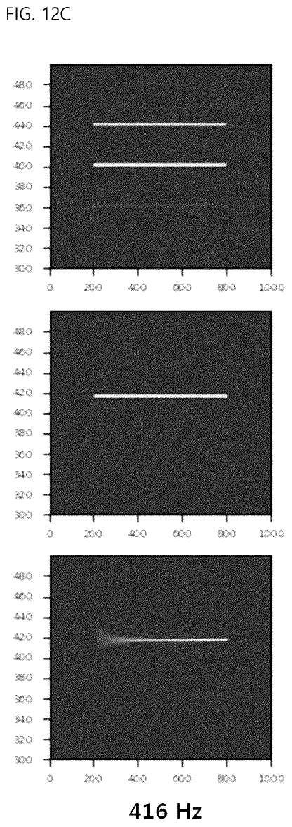

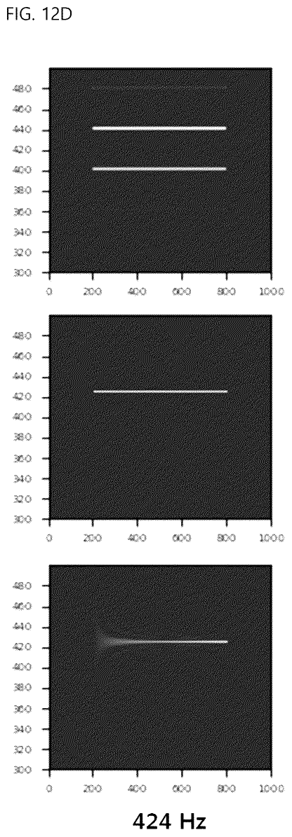

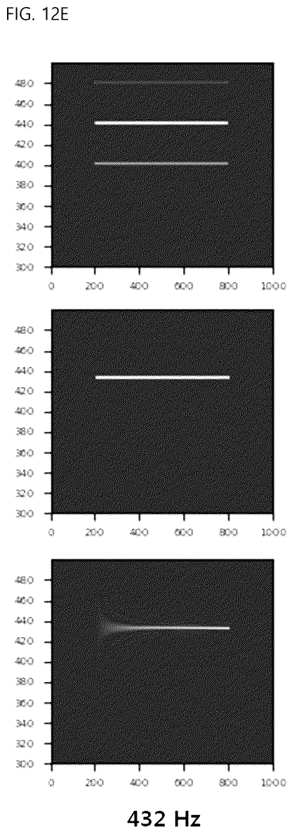

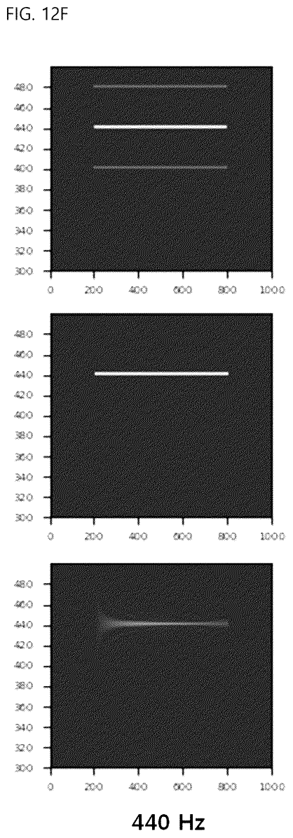

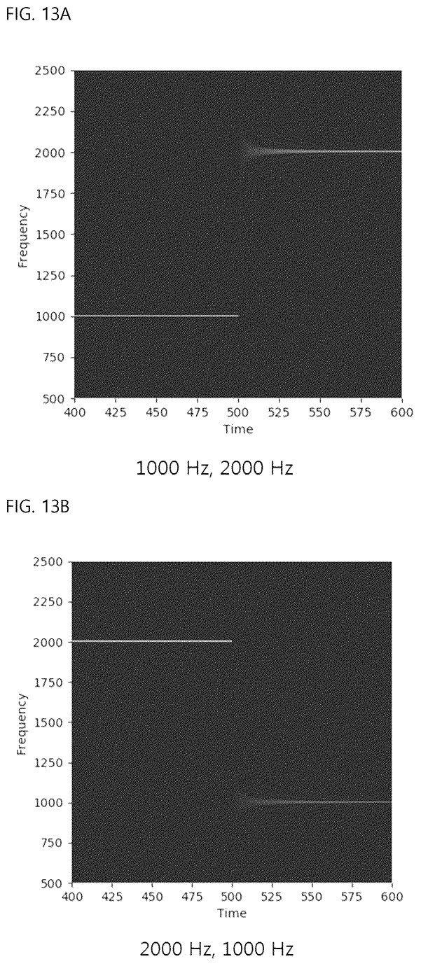

FIGS. 12A to 12F are diagrams showing the results of the STFT and the DJ transform in terms of the frequency resolution. In FIGS. 12A to 12F, the first rows show the results of the STFT, the second rows show the frequencies of the input sounds, and the third rows show the results of the DJ transform according to an embodiment of the present disclosure.

As shown in FIGS. 12A to 12F, the frequency resolution of the STFT result was 40 Hz. In addition, when the frequencies of pure tones were 400 Hz, 408 Hz, and 416 Hz, the peak was output at 400 Hz, and when the frequencies of pure tones were 424 Hz, 432 Hz, and 440 Hz, the peak was output at 440 Hz. However, the DJ transform results were matched with all the frequencies of pure tones. That means the frequency resolution of the DJ transform result was 1 Hz.

Three experiments were conducted to compare the results of the DJ transform with the STFT in terms of temporal resolution.

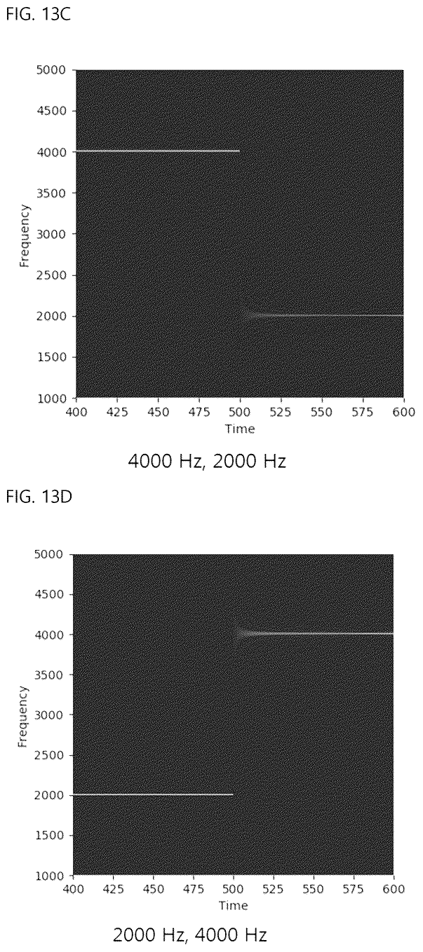

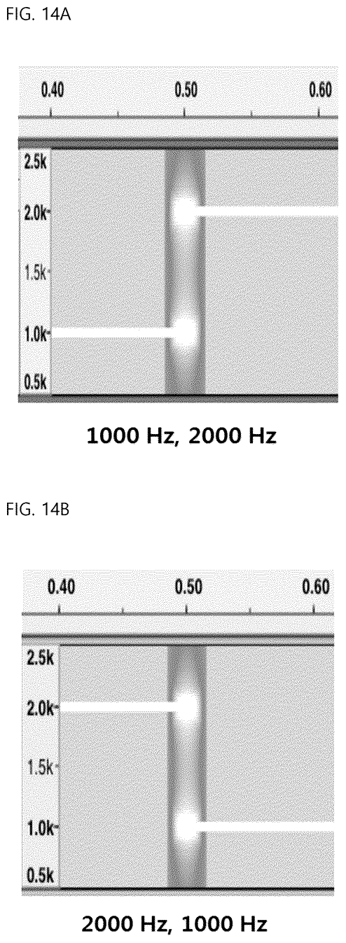

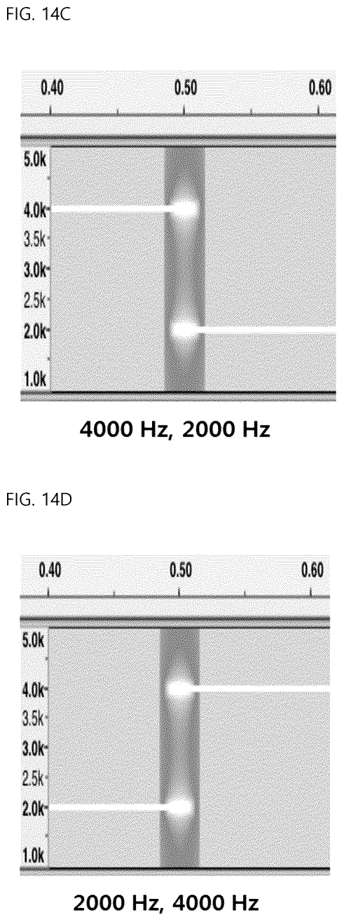

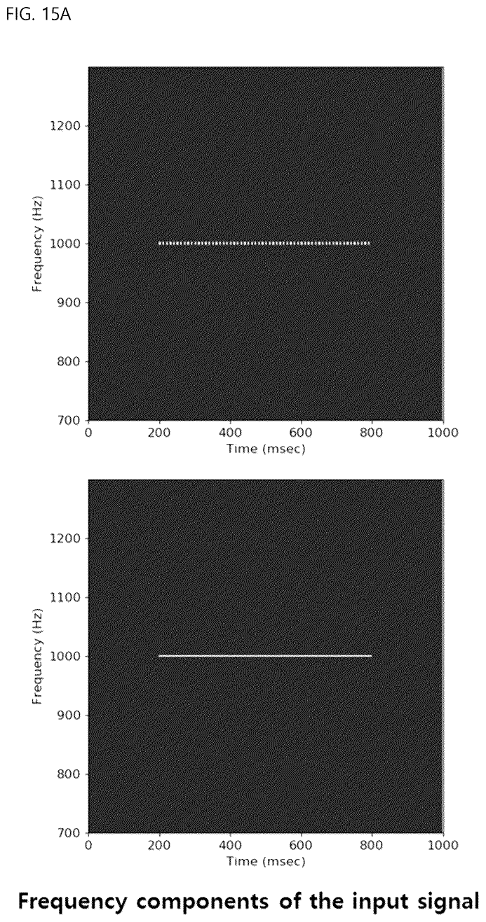

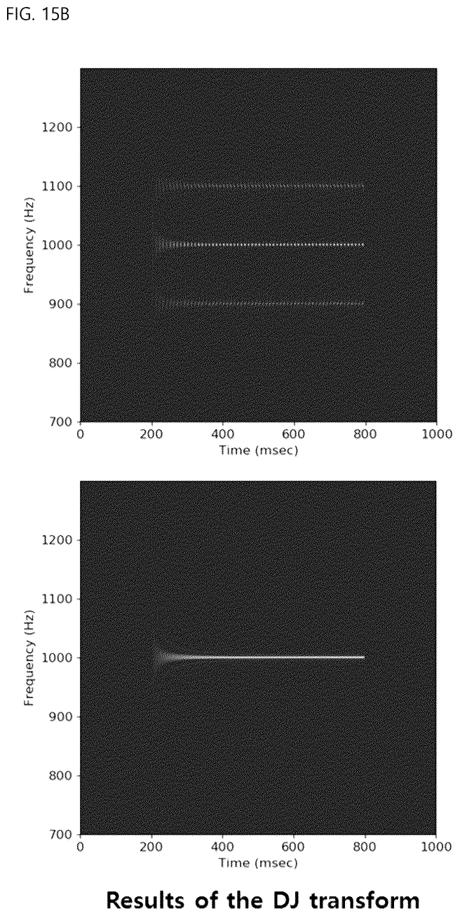

The first experiment was to check the frequency extracted at the time point where an input frequency changes. FIG. 13A shows a result of extracted frequencies by the DJ transform when a 1 kHz pure tone had been input for 500 milliseconds and a 2 kHz pure tone was input just after 500 milliseconds, FIG. 13B shows a result of extracted frequencies by the DJ transform when a 2 kHz pure tone had been input for 500 milliseconds and a 1 kHz pure tone was input just after 500 milliseconds, FIG. 13C shows a result of extracted frequencies by the DJ transform when a 4 kHz pure tone had been input for 500 milliseconds and a 2 kHz pure tone was input just after 500 milliseconds, and FIG. 13D shows a result of extracted frequencies by the DJ transform when a 2 kHz pure tone had been input for 500 milliseconds and a 4 kHz pure tone was input just after 500 milliseconds. Obviously, FIGS. 13A to 13D show that the boundaries between the two frequencies were at 500-milliseconds. Specifically, until 500 milliseconds, the frequencies of 1 kHz, 2 kHz, 4 kHz and 2 kHz of the input pure tones were clearly displayed, and immediately after 500 milliseconds, the frequencies of 2 kHz, 1 kHz, 2 kHz and 4 kHz of the changed pure tone were displayed with about 10% error only. However, in the STFT results shown in FIGS. 14A to 14D, two frequencies are simultaneously extracted on the 500-millisecond boundary.

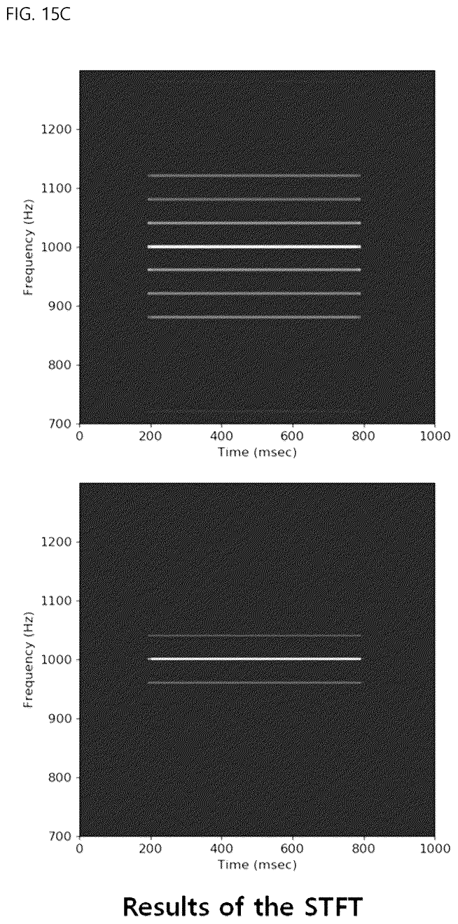

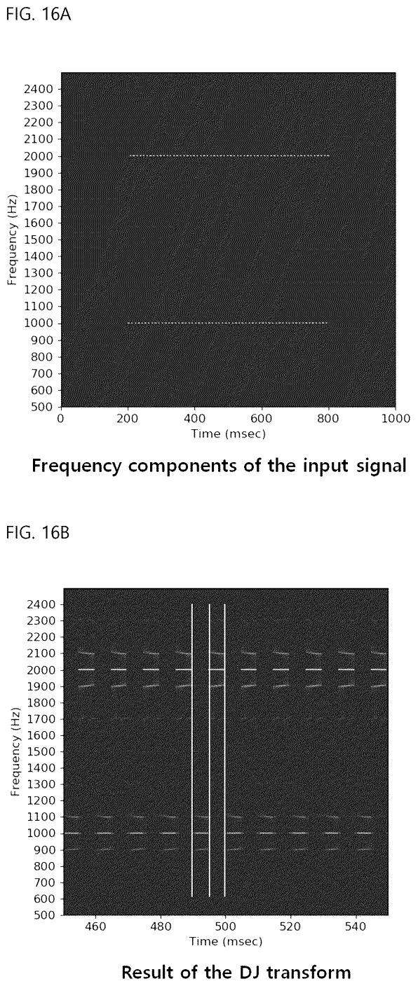

The second experiment is to extract frequencies from the sounds that appear and disappear rapidly. The first rows of FIGS. 15A to 15C show the frequency extraction results when a 1 kHz pure tone is generated for 5 milliseconds, and silent for the next 5 milliseconds from 200 milliseconds to 800 milliseconds (when a flicker signal is repeatedly input). The second rows show the results when a 1 kHz pure tone continuously is input from 200 milliseconds to 800 milliseconds (when a continuous signal is input). FIG. 15A is for the frequency components of the input sound over time, FIG. 15B is for the DJ transform results, and FIG. 15C is for the STFT result.

In FIG. 15B showing the results of DJ transform, the repeated flicker signal results in a broken line while the continuous signal results in a solid line thereby two signals are distinguished apparently. On the other hand, the results of the STFT shown in FIG. 15C show a solid line at 1 KHz, therefore, the distinction between the flicker signal and the continuous signal is not clear.

The upper drawing in FIG. 15B shows relatively weak broken lines at 1.1 kHz and 0.9 kHz. These lines are interpreted as the result of 100 Hz signal due to the repeated input of every 10 milliseconds cycle. On the other hand, in the STFT result, solid lines appear at 0.88 kHz, 0.92 kHz, 0.96 kHz, 1.04 kHz, 1.08 kHz and 1.12 kHz when looking at the upper drawing in FIG. 15C. It is conjectured that the reason the STFT result occurs is because 0.9 kHz and 1.1 kHz frequency components are generated by the 100 Hz signal and those components are represented by 40 Hz intervals due to the 40 Hz frequency resolution of the STFT.

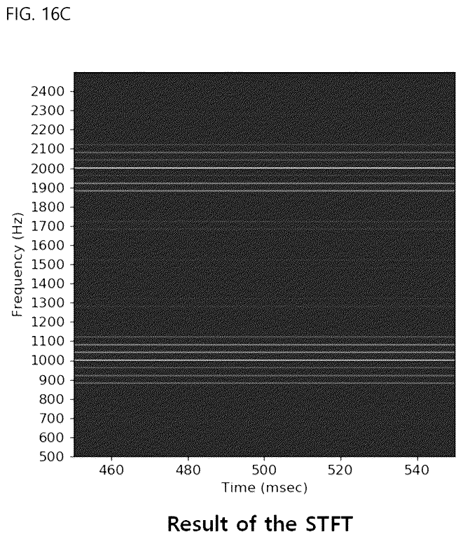

The third experiment is an extension of the second experiment, which shows the results in frequency extraction when a 1 kHz and a 2 kHz pure tones are alternately generated for 5 milliseconds from 200 milliseconds to 800 milliseconds (FIGS. 16A to 16C). FIG. 16B shows that the DJ transform produces the 1 kHz pure tone and the 2 kHz pure tone that are clearly separated in 5 milliseconds units. On the other hand, when the STFT is used, boundaries between the pure tones are not distinguishable as shown in FIG. 16C.

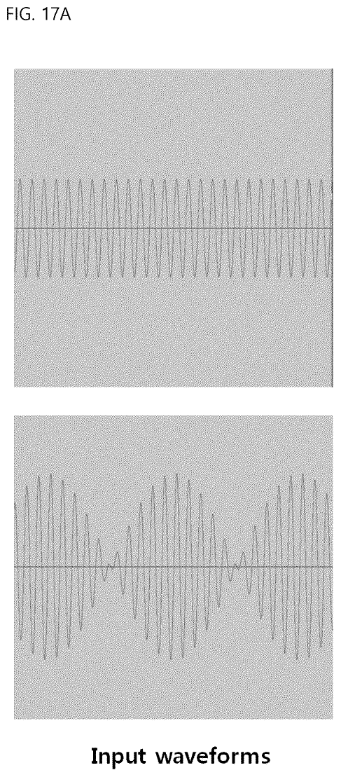

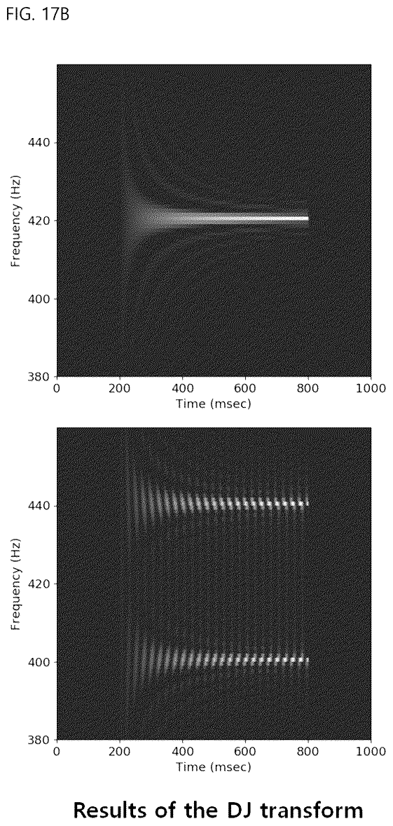

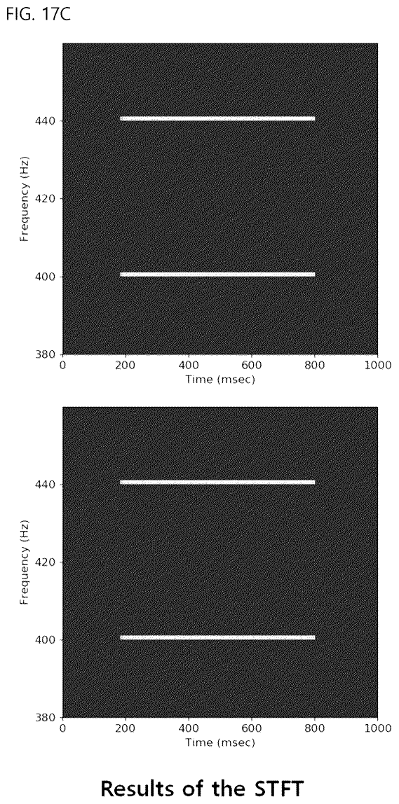

The first rows of FIGS. 17A to 17C show the input waveform, the result of the DJ transform, and the result of the STFT when a 420 Hz pure tone is input, and the second rows show the input waveform, the DJ transform result, and the STFT result when a complex tone composed of 400 Hz and 440 Hz is input. FIG. 17A shows input waveforms, and FIGS. 17B and 17C show the DJ transform results and the STFT results, respectively.

As can be seen in FIG. 17B and 17C, the DJ transform extracts 420 Hz frequencies from a pure tone, and 400 Hz and 440 Hz frequencies from a complex tone. On the other hand, there is little difference between the results extracted from both pure tones and the complex tone with the STFT.

Since the complex tone is composed of 400 Hz and 440 Hz, the amplitude fluctuates in a 40 Hz cycle as shown in the bottom of FIG. 17A. On the other hand, as in the bottom of FIG. 17B, the DJ transform well reflects the characteristic of the amplitude fluctuation. Although the present disclosure has been described in detail through

preferred embodiments, the present disclosure is not limited thereto, and various changes and applications can be made without departing from the technical spirit of the present disclosure, which is obvious to a person skilled in the art. Therefore, the scope of protection for the present disclosure should be interpreted by the following claims, and all technical ideas within the scope equivalent thereto should be interpreted as being included in the scope of the present disclosure.

1. A sound processing device comprising:
a spring modeling unit that calculates displacement and velocity of each of the plurality of springs by modeling a plurality of springs, each of which has a different natural frequency and vibrates according to an input sound, and calculates displacement, velocity, energy, and amplitude of each of the plurality of springs by modeling a plurality of springs, each of which has a different natural frequency and vibrates according to an input pure tone;
a frequency extraction unit that extracts the natural frequency of the spring corresponding to the local maximum among the filtered pure tone amplitudes calculated by the spring modeling unit;
a sound recognition and synthesis unit that recognizes and synthesizes sound by using the amplitude or natural frequency of the input pure tone; and
an error inspection unit that checks the excess error of the conversion result of the frequency when the frequency of the plurality of input springs changes and inspects the error between the pure tone frequencies.

2. The device according to claim 1,
the spring modeling unit comprises:
a spring frequency modeling module that models natural frequencies of a plurality of springs having different natural frequencies and vibrating according to input sound;
a filtered pure tone amplitude determination module that determines filtered pure tone amplitudes of the plurality of springs;
an amplitude calculation module that calculates transient pure tone amplitudes of the modeled plurality of springs, calculates expected steady-state amplitudes of the modeled plurality of springs, calculates predicted pure tone amplitudes based on the expected steady-state amplitudes, and calculates filtered pure tone amplitudes by multiplying the transient pure tone amplitude by the predicted pure tone amplitude;
an expected steady-state amplitude estimation module that estimates the expected steady-state amplitude of a spring having the largest amplitude among the modeled plurality of springs;
a spring energy calculation module that calculates the energy of at least one spring having the largest amplitude among the plurality of springs based on the expected steady-state amplitude; and
an input pure tone amplitude calculation module that calculates the amplitude of the input pure tone based on the energy.

3. The device according to claim 1,
the sound recognition and synthesis unit is characterized by performing speech recognition; speaker verification; speaker identification; source separation; sound direction detection; sound-based nomenclature diagnostics; sound-based machine fault diagnostics;
or Sonar for navigation undersea terrain or ranging objects.

4. The device according to claim 1,
the error inspection unit is characterized in that,
when the frequency of the plurality of input springs is maintained at a first value until a certain point of time and turns to a second value at the certain point, the frequency conversion result up to the certain point is indicated as the first value, and immediately after the turning point, the transient error from the first value to the second value is checked to be within 10%, thereby inspecting the error between pure tone frequencies.

5. A sound processing method comprising the steps of:
modeling, by a spring modeling unit, natural frequencies of a plurality of springs, the plurality of springs having natural frequencies different from each other and oscillating according to an input sound;
determining, by the spring modeling unit, filtered pure-tone amplitudes of the plurality of springs:
calculating, by the spring modeling unit, transient-state-pure-tone amplitudes of the plurality of modeled springs;
calculating, by the spring modeling unit, expected steady-state amplitudes of the plurality of modeled springs;
calculating, by the spring modeling unit, predicted pure-tone amplitudes based on the expected steady-state amplitudes;
calculating, by the spring modeling unit, filtered pure-tone amplitudes by multiplying the transient-state-pure-tone amplitudes with the predicted pure-tone amplitudes;
extracting, by a frequency extraction unit a natural frequency of at least one spring of the plurality of springs which corresponds to a local maximum value among the filtered pure-tone amplitudes; and
using, by a sound recognition and synthesis unit, the natural frequency for sound recognition or sound synthesis.

6. The method according to claim 5, wherein said expected steady-state amplitude is calculated based on the amplitudes at least two time points within a duration of the input sound.

7. The method according to claim 5, wherein said expected steady-state amplitude is calculated by the equation below:
$${A}_{i , s} = \frac{{A}_{i} ( {t}_{2} ) - {A}_{i} ( {t}_{1} ) {e}^{- ζω ( {t}_{2} - {t}_{1} )}}{1 - {e}^{- ζω ( {t}_{2} - {t}_{1} )}}$$
where Ai,s is the expected steady-state amplitude of i-th spring Si among the plurality of springs, wherein I is a positive integer,
where t1 and t2 are two different time points within a duration of the input sound, t2>t1,
Ai(t1) is an amplitude of said
spring Si at t₁, Ai(t₂) is an amplitude of
said spring Si at t₂, ζ is a damping ratio of
said spring Si, and
ω satisfies the equation ω=ωᵢ\sqrt{1−2ζ²}, where ωi is the natural frequency of said spring Si.

8. The method according to claim 6, wherein a difference between the two different time points is a period of the natural frequency of the corresponding spring.

9. The method according to claim 6, wherein if one of the two time points is t1, a sampling rate of the input sound is SR, and a period of the natural frequency of the corresponding spring is T, then the other t2 of the two time points is calculated by the equation below:
$${t}_{2} = [ {t}_{1} + SR \times T + 0.5 ] .$$

10. The method according to claim 6, wherein the expected steady-state amplitude is calculated by substituting amplitudes at least two points in the duration of the input sound into the following equation and using a linear regression analysis:
$$A ( t ) = {A}_{s} + ( {A}_{c} - {A}_{s} ) {e}^{- ζω ( t - {t}_{c} )}$$
where A(t) is an amplitude of any spring among said plurality of springs at t, As is the expected steady-state amplitude of said spring,
A_{c} is an amplitude of said spring at tc,
tc is a time point before the at least two points in the duration of the input sound,
ζ is a damping ratio of said spring, and
ω satisfies the equation ω=ωᵢ\sqrt{1−2ζ²}, where ωi is the natural frequency of said spring.

11. The method according to claim 5, wherein the spring modeling unit is characterized by performing the steps of:
measuring displacements and velocities at time points for each of the plurality of springs;
calculating an energy at each time point for each of the plurality of springs based on the displacements and the velocities; and
calculating an amplitude at each time point for each of the plurality of springs based on the energy.

12. The method according to claim 5, wherein the number of the plurality of springs is determined based on a range and a resolution of the frequency to be extracted.

13. A sound processing method comprising the steps of:
sampling, by a spring modeling unit, natural frequencies of a plurality of springs, the plurality of springs having natural frequencies different from each other and oscillating according to an input sound;
estimating, by the spring modeling unit, an expected steady-state amplitude of the spring of which the amplitude is the highest among the plurality of modeled springs;
calculating, by the spring modeling unit, an energy of at least one spring of the plurality of springs of which the amplitude is the highest based on the expected steady-state amplitudes;
calculating, by the spring modeling unit, an amplitude of the input pure tone based on the energy; and
using, by a sound recognition and synthesis unit, the amplitude of the input pure tone for sound recognition or sound synthesis.

14. The method according to claim 13, wherein said expected steady-state amplitude is calculated by the equation below:
$${A}_{i , s} = \frac{{A}_{i} ( {t}_{2} ) - {A}_{i} ( {t}_{1} ) {e}^{- ζω ( {t}_{2} - {t}_{1} )}}{1 - {e}^{- ζω ( {t}_{2} - {t}_{1} )}}$$
in which Ai,s is the expected steady-state amplitude of a spring Si among the plurality of springs, said spring Si of which amplitude being the highest among amplitudes of the plurality of springs at each time point, wherein I is a positive integer,
t1 and t2 are two time points within a duration of input sound satisfying
t2>t1, Ai(t1) is an amplitude of said spring Si at t1,
Ai(t2) is an amplitude of said spring Si at t2,
ζ is a damping ratio of said spring, and
ω satisfies the equation ω=ωᵢ\sqrt{1−2ζ²}, where ωis the natural frequency of said spring of which the amplitude is the highest.

15. The method according to claim 13, wherein the spring modeling unit is characterized by performing the steps of:
measuring a displacement and a velocity at each time point for each of the plurality of springs;
calculating an energy at each time point for each of the plurality of springs based on the displacement and the velocity; and
calculating an amplitude at each time point for each of the plurality of springs based on the energy.
